(19) United States
(12) Patent Application Publication
(10) Pub. No.: US 2025/0146859 A1
(43) Pub. Date: May 8, 2025

(54) SMART PORTION WEIGHING SYSTEM

(71) Applicant: Roi SHUKER, Beer Sheva (IL)

(72) Inventor: Roi SHUKER, Beer Sheva (IL)

(21) Appl. No.: 18/836,370

(22) PCT Filed: Feb. 20, 2023
(86) PCT No.: PCT/IL2023/050178

§ 371 Date: Aug. 7, 2024

Related U.S. Application Data
(60) Provisional application No. 63/313,282, filed on Feb. 24, 2022.

(51) Int. Cl. G01G 19/56; G01F 22/00; G01G 23/37; G07G 1/01

(52) U.S. Cl. CPC G01G 19/56; G01F 22/00; G01G 23/3735; G07G 1/01

(57) ABSTRACT

The present invention, in some embodiments thereof, relates to a handheld electronic measuring container and, more particularly, but not exclusively which may convey information to and/or from a user and/or a network system.

### RELATED APPLICATION/S

This application claims the benefit of priority under 35 USC § 119(e) of U.S. Provisional Patent Application No. 63/313,282 filed 24 Feb. 2022, the contents of which are incorporated herein by reference in their entirety.

### FIELD AND BACKGROUND OF THE INVENTION

The present invention, in some embodiments thereof, relates to an electronic measuring container and, more particularly, but not exclusively which may convey information to and/or from a user and/or a network system.

In the food industry the weight of both the ingredients and of the portions served is a critical factor in the cost of the products. For example, in order to produce a food product having the same flavor and texture reproducibly relies on knowing the exact weight or volume of the ingredients used. In addition, customers buying produce such as, herbs, spices, dry ingredients, wet ingredients, meat, fish, poultry, etc., are usually charged by weight or volume. Further, deli counters, fresh food markets and many restaurants charge by weight or volume for their products. Many other industries also require precise measurement of various parameters of the starting materials or products. However, measurement by quantity, mass and/or volume tends to be time consuming, and imprecision may be costly. Additionally, scales and other measuring devices tend to be difficult to transport and may require careful handling to ensure that their accuracy is maintained.

For example, measurement may require a user to look at an order report and/or other document that may present the desired measure, the user may then need to fill an electronic container and/or put the electronic container on a scale and/or then add or subtract goods and/or articles from the electronic container until the desired amount is reached, the user may then need to report the amount that in the electronic container to the cashier.

For example, a restaurant may have a system where a customer orders food and/or drinks at a table and/or at the counter. The restaurant may then send the order report to the kitchen to make the order. The cooks may then read the order and use various containers and/or scales to measure the right amount of food to be provided to the customer.

Therefore, there is a need for a rapid, easy to use, portable device for measuring the parameters of materials, e.g., quantity, mass or volume of food produce and/or food products.

US Published Patent Application no. 20090133940 appears to disclose, “weighing serving implement has a head to serve food and is mounted to a mount at a pivot point. The pivot point provides a mechanical balance and facilities a rugged and washable design.”

U.S. Pat. No. 6,236,001 appears to disclose that, “A scoop has a handle attached thereto by a neck. The neck has a built-in strain gauge supporting the scoop which measures weight in the scoop. An analog-digital converter converts the strain gauge output to a digital signal, which displays the weight as a readout (either metric or avoirdupois) on a panel in the handle. Control switches built into the handle or panel control the functions of the scoop, while indicator/annunciator lights indicate status. A level indicator is provided having a ball bearing resting freely on a conducting bottom plate forming a spherical sector of predetermined angle and a cylindrical sidewall having therein conducting elements. When the ball bearing contacts a sidewall conducting element it closes a circuit which switches off a level indicator/annunciator light, which when on shows that the scoop is level. The position of the ball bearing is visible to the operator, allowing correction of tilt. The predetermined angle is set between 8 and 12°, so that tilts greater than 4 or 6° are visually indicated.”

International Published Patent Application No. WO2020230139 appears to disclose, “An apparatus comprising a force and orientation measuring sensors, and a calculating module. Said calculating module comprising a processing unit, a memory, and a code designed to calculate the accurate weight of the content of a utensil while held in any angle and orientation or rest upon any surface.”

US Published Patent Application no. US20070028453 appears to disclose that, “A portion control, food serving system comprises a series of two or more interchangeable utensil portions configured to receive an amount of food, a handle portion, removably and operably attachable to one of the utensil portions incorporating a display device and a data input system, and electronics to operate the data input system and the display device. The data input system is operable to receive nutritional data associated with the food, including a standard serving size of the food. The electronics are operable to weigh the amount of food received on one of the utensil portions and produce a visual representation on the display device of the amount of food relative to the standard serving size of the food.”

German Published Patent Application No. DE102005062980A1 appears to disclose that, “The device has a handle (23), a spoon body (11) and a weight sensor (12), whereby the handle is designed to be gripped and held by the user's hand and the weight sensor lies in the force path between the spoon body and the handle. It has a horizontal sensor (7) for measuring the alignment of the spoon balance relative to a horizontal plane.”

U.S. Pat. No. 8,127,605 appears to disclose, “a portable measuring vessel with a removably attached digital measuring device. The digital measuring device includes one or more load cells, one or more processors, an input unit, and an output unit. Preferably the input unit is one or more finger-actuatable switches and the output unit is a visual display, such as an LCD. The processor is connected to the input, output, load cell and power source, thereby making a convenient, portable and easily used product.”

US Published Patent Applicaiton no. 20070034421 appears to disclose, “a weighing spoon, comprising a spoon body, a holder body, and a level meter, wherein the spoon body is connected via a spoon stem with a weighing sensor disposed in the holder body, and the level meter is mounted in the holder body having a hanging ring attached thereto. A liquid crystal display is disposed in the holder body. The weighing sensor is connected to the liquid crystal display by means of A/D converter on the circuit board and a circuit of a microprocessor. The holder body is a housing composed of the panel, a button, an upper case, a lower case and a battery cover. In the interior of the holder body are disposed a rubber button and a circuit board and a battery. A seal ring is provided between the battery cover and the lower case to improve water resistance thereof. The weight indicated by the weighing sensor is displayed on the liquid crystal display when needed, and the level meter is used to control the data read from the spoon in the horizontal state most accurate. The spoon according to the present utility model is reasonable in structure, and a user can precisely control the amount of the article needed, and meanwhile the spoon can be conveniently placed by means of a hanging ring provided.”

U.S. Pat. No. 6,573,462 appears to disclose that, “A scoop has a handle attached thereto by a neck, and a load receiving vessel. The neck has a built-in load cell and strain gauge supporting the load receiving vessel, which measures weight in the scoop. An analog-digital converter converts the strain gauge output to a digital signal, which displays the weight as a readout. Control switches built into the handle or panel control the functions of the scoop, while indicator/annunciator lights indicate status. Either an inclinometer is provided to correct the weight for tilting, or a visible ball bearing switch is provided to cut off the display at a predetermined angle of tilt. Shock loading protection is provided by a flexmount for the load cell, which gives when a predetermined load is applied, which also provides overload protection. Overload protection is also provided by a check rod or load stop built into the load cell.”

U.S. Pat. No. 412,049 appears to disclose, “an automatic weighing-scoop that will be accurate in its movements, have few parts, and the indicating-dial of which is so situated as to be readily observed by the clerk.”

### SUMMARY

According to an aspect of some embodiments of the invention, there is provided a handheld electronic measuring device including: a container with a measuring system configured to measure a parameter of a contents of the container; and a user interface configured to output a result from the measuring system.

According to some embodiments of the invention, the parameter of the contents is a mass.

According to some embodiments of the invention, the parameter of the contents includes at least one of volume, length and quantity.

According to some embodiments of the invention, the device further includes a network connection.

According to some embodiments of the invention, the device is configured to interconnect with a cash register over the network connection.

According to some embodiments of the invention, the device is configured to determine to receive a quantity to measure over the network connection and indicate over the user interface when the container contains the quantity.

According to some embodiments of the invention, the device is configured to transmit to the cash register a quantity measured.

According to some embodiments of the invention, the network connection includes at least one of a wi-fi connection, a Bluetooth.

According to some embodiments of the invention, the device further includes a handle.

According to some embodiments of the invention, the user interface is located on the handle.

According to some embodiments of the invention, the device further includes a printer.

According to some embodiments of the invention, the device further includes a scanner.

According to some embodiments of the invention, the device further includes at least one sensor.

According to some embodiments of the invention, the at least one sensor is a multiple load sensor, an accelerometer, or a gyro or any combination thereof.

According to some embodiments of the invention, the device further includes: a processor configured to adjust a measured quantity to account for a condition measured with the at least one sensor.

According to some embodiments of the invention, the condition includes at least one of an acceleration of the device and an angle of the device with horizontal.

According to some embodiments of the invention, the user interface includes a visual system, an audio system, vibration system or any combination thereof.

According to some embodiments of the invention, the container is configured to have a variety of shapes and sizes.

According to some embodiments of the invention, the container is configured to be interchangeable between containers of various shapes and various sizes.

According to some embodiments of the invention, the device further includes a detachable insert for the container.

According to some embodiments of the invention, the device is portable.

According to an aspect of some embodiments of the invention, there is provided a method for measuring contents of a container, the method including: inserting an amount of a product to be measured into an electronic container; determining a parameter of a contents of the electronic container; reporting the parameter to a user.

According to some embodiments of the invention, the parameter of the contents is a mass.

According to some embodiments of the invention, the parameter of the contents includes at least one of volume, length and quantity.

According to some embodiments of the invention, the measuring is measuring to obtain a pre-determined or desired quantity.

According to some embodiments of the invention, the method further includes sending the pre-determined or desired quantity to the electronic container.

According to some embodiments of the invention, the sending is by a wi-fi connection, Bluetooth connection, or both.

According to some embodiments of the invention, the sending is by scanning a barcode, QR code, RFID.

According to some embodiments of the invention, the reporting is by a user interface including a visual system, an audio system, vibration system or any combination thereof.

According to some embodiments of the invention, the reporting is by printing receipt.

According to some embodiments of the invention, the reporting is input to a billing apparatus.

According to some embodiments of the invention, the reporting is by a wi-fi connection, Bluetooth connection, or both.

According to some embodiments of the invention, the method is used for large, small or medium objects.

### DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the figures:

FIG. 1A-D are schematic diagrams illustrating an embodiment of the current invention;

FIG. 2 is a schematic diagram illustrating an embodiment of the current invention;

FIG. 3 is a schematic diagram illustrating an embodiment of the current invention;

FIG. 4 is a schematic diagram illustrating any embodiment of the current invention;

FIG. 5A-C are schematic diagrams illustrating any embodiment of the current invention;

FIG. 6 is a block diagram illustrating an embodiment of the current invention;

FIG. 7 is a block diagram illustrating an embodiment of the current invention;

FIG. 8 is a flow chart illustrating an embodiment of the current invention;

FIG. 9 is a flow chart illustrating an embodiment of the current invention;

FIG. 10 is a perspective view of a weighing spatula in accordance with an embodiment of the current invention;

FIG. 11 is a flow chart illustrating method of weighing in accordance with an embodiment of the current invention;

FIG. 12 is a block diagram illustrating an optional embodiment of the current invention;

FIG. 13 is a block diagram illustrating an optional embodiment of the current invention;

FIG. 14 is a block diagram of a position sensing mechanism in accordance with an embodiment of the current invention;

FIGS. 15A and 15B are perspective views of a weighing spatula from above and below in accordance with an embodiment of the current invention.

### DESCRIPTION OF SPECIFIC EMBODIMENTS OF THE INVENTION

The present invention, in some embodiments thereof, relates to an electronic measuring container (e.g., tray, spatula, scoop, spoon, etc.) and, more particularly, but not exclusively which may convey information to and/or from a user and/or a network system (e.g., how much to weigh, how much was weighed, when a desired weight is reached, etc.).

### OVERVIEW

An aspect of some embodiments of the current invention relates to an electronic measuring container, and more particularly, but not exclusively, which may measure weight, volume, etc. According to some embodiments, the electronic measuring container may convey information to and/or from a user and/or a network system.

According to some embodiments, various items and/or goods may be sold and/or arranged according to a desired weight and/or a desired volume and/or other desired size measurements. Optionally, a user may use an electronic container and/or a handling device and/or a measuring device to identify when a desired weight and/or volume may be reached. Optionally, there may be various actions that may need to be undertaken to measure the various items and/or goods and/or articles properly.

According to some embodiments, the current invention is a system that may enhance efficiency in processing and/or measuring and/or delivering goods and/or products. An embodiment of the current invention may include an electronic container that may be portable and/or may function to measure products and/or goods. For example, an electronic container may be configured to measure mass and/or volume and/or quantity and/or length and/or other measurements.

Additionally, or alternatively, according to some embodiments, an electronic container may include a system for communicating with a user, for example, a screen and/or lights and/or sounds. For example, an electronic container may communicate various details about the content of the electronic container to a user, such as the volume and/or weight, etc. of the contents. Optionally, the electronic container may include a user interface, e.g., one or more buttons, a touch screen, etc. Optionally, the user may input data to the electronic container, e.g., the desired amount of a product, good or item, the cost per unit of a product, good or item, etc. Optionally, the electronic container may be pre-programmed, e.g., with the cost per unit of a product, good and/or item, etc. Optionally, the electronic container may be programmed to convert one form of measurement to and/or from another form of measurement, e.g., the weight of a known liquid to its corresponding volume, etc. Optionally, the user may be a skilled worker, e.g., a chef, kitchen worker, shop assistant, laboratory worker, pharmaceutical dispenser, etc. and/or the user may be unskilled, e.g., a shopper, etc. Optionally, such an electronic container may make the measuring of goods and/or food and/or products and/or produce more efficient and/or faster.

Additionally, or alternatively, an embodiment may include a system in which the electronic container may connect to a network (e.g., a local network and/or an Internet network) and/or may receive information and/or convey information to various other parts of a network. For example, an embodiment may be designed for a restaurant that food orders may be sent (e.g., by wi-fi) from a cash register and/or ordering station to the electronic container being used by the kitchen staff and/or the electronic container may help the kitchen staff to measure the desired portions (e.g., by signaling to them what to measure/add/subtract, how much to measure/add/subtract, and/or when they have reached the correct measurement) and/or the electronic container may send a report to the cash register and/or to a waiter that the food is ready and/or the actual weight or the food, which may then be charged accordingly.

According to some embodiments, the electronic container may be of various sizes, and/or shapes. For example, the electronic container may be large (e.g., for measuring bulk foods, such as dry ingredients, food portions, fresh produce, etc.) and/or small (e.g., for measuring spices and/or medicine, etc.). Optionally, the system may be used for large and/or small and/or medium objects (e.g., bulk food, restaurant portions, spices, medicine, etc.). Optionally, the electronic container may be scoop shaped (e.g., for dry ingredients, spices, sweets, shawarma, etc.), and/or tray shaped (e.g., for liquids, meat, fish, poultry portions, vegetables, etc.) and/or cup shaped (e.g., for liquids, dry ingredients, etc.), and/or other shapes. Optionally, the electronic container may be configured to allow attachment of various shaped containers to be reversibly attached and/or detached, e.g., depending on the item, good, product, and/or produce being measured. Optionally, the electronic container may be configured to interchangeably attach and/or detach various container of various shapes and/or sizes. Optionally, the electronic container may be portable. Optionally, the electronic container may be handheld. Optionally an electronic container may have a handle.

According to some embodiments, the electronic container may include multiple load sensors, an accelerometer, and/or a gyro. Optionally, such sensors may be coupled to a processor e.g., to make allowance for movement of the electronic container and/or variations in the position of the object being weighed and/or the angle of the electronic container with respect to gravity, for accurate measurement in various cases.

In some embodiments, an electronic container may be designed for use in the food industry. In the food sales industry (dining and/or fast-food and/or shopping etc.) there may be various foods. Many foods are sold by weight and/or there may be various foods that the norm for selling them may be by estimate.

An example of a food sometimes sold by estimate may be shawarma. There may be a need to aid in measuring amounts of food and/or measuring quickly without needing to do an addition action in the production/preparation line, such as putting food on a scale and checking the weight and/or adding and/or removing food to get to a desired amount. Many business owners who sell foods and/or users buying and/or handling and/or preparing food, may wish to keep track of the weight of the food they are handing (this may a need for handling non-edible substance also). For example, a restaurant and/or specifically a restaurant may want to increase service speed as much as possible. Specifically, but not exclusively shawarma restaurants may find it hard to keep track of the amount fed per serving and as a result may have challenges in planning quantities over time. Also, the lack and/or challenge in serving a standard amount may interfere in maximizing profits and growth of the business. For example, workers may be serving too much and/or too little to the customers. In addition, there may be customers who request larger portions of food and/or shawarma during preparation and the business owner may not have a system and/or way of pricing this. It may be not worthwhile to place on a scale for the handler of the shawarma (and/or other food and/or substance), to determine the right amount of meat so that the customer is satisfied and/or that the seller may make a desired profit and/or to increase efficiency and/or speed.

Some embodiments of the current invention may be a bowl and/or container that may also have a weight scale function. This scale function may optionally be simultaneous to the handling of the substance. For example, the scale may show the weight of the content in the scoop/container such that the user just needs to glance to see how much is the food. Some embodiments may be designed to help handle specific foods. For example, a device may be developed for Shawarma (e.g., in a fast-food stand they cut meat off a large piece and serve pieces of meat to a customer) and/or for other foods. Optionally, a device may contain a lever mechanism that detects the weight change as soon as you lower the content into it. Optionally a device may have a digital monitor and/or a battery housing. According to some embodiments, the method may be used for large and/or small and/or medium objects (e.g., bulk food, restaurant portions, spices, medicine, etc.). Optionally, the method may include weighing with an electronic container, such as a scoop, tray, etc.

In some embodiments an electronic container may include a pot and/or scoop and/or a spoon with a weight scale system. Optionally, the scale may be electronic and/or mechanical. The scale may detect the weight of the contents of the container/scoop etc. For example, an embodiment may be a container that may fit into and/or onto another container. There may be a sensor at the bottom and/or side of the outer container that may detect the weight pressure that is increased by the contents put into the inner (or upper) container. The weight may then be displayed. Optionally there may be an embodiment that the container and/or the bottom of a container is held lower than the device and the device may detect how much pressure is being pulled downwards. In some embodiments, the container may be shaped to distribute weight evenly even when tipped at an angle. For example, a rounded container may be weighed as it is displaced toward a rounded mount by gravity.

In some embodiments, the container into which the continent is placed\may be Figs attached to the rest of the invention and/or optionally the container may be detachable and/or entirely not secured. A container may be, for example, between 0 to 10 milliliters and/or between 10 milliliters to 100 milliliters and/or between 100 milliliters to 1 liter and/or between 1 liter to 5 liters and/or between 5 liters to 10 liters and/or between 10 liters to 100 liters. The scale may be able to measure between 0 to 1 gram and/or between 1 to 100 gram and/or between 100gram to 250 gram and/or between 250 grams to 1 kilogram and/or between 1kilogram to 10 kilograms and/or between 10 kilograms to 100 kilograms.

In some embodiments, the container may have a data screen. Some embodiments may show weight of content and/or angle the container is being held and/or other information and/or an indicator when the weight is accurate (e.g., because the angle is proper and/or the device is still and/or because the detected weight is stable [e.g., not changing more than a tolerance over a set period of time]). Optionally an embodiment may have various control buttons. Optionally there may be a way to change the 0 setting on the scale. Optionally an embodiment may have multiple containers and/or various sized containers that may be interchangeable to the device. For example, there may be a need to clean the container and/or there may be a method to attach one container for a period of time and then take it off and/or then attach a replacement container for a period of time. This might help that a user can clean all the containers after he is finished with their use. Optionally there may be a setting to change the accuracy of the scale. Optionally, a custom scale may be defined. For example, in place of or in addition to giving a weight the display may indicate if the quantity is with a serving and/or there may be an indicator of a large serving, a small serving and/or a medium serving and the like (for example each serving and/or dish may have a range of weight etc.). The indicator may be textual and/or a colored light and/or a region of a scale etc.

In some embodiments a container, when held parallel to the ground, may be between 0 to 10 mm deep and/or between 10 to 50 mm deep and/or between 50 mm to 1 meter deep. A container may be between 0 to 10 mm wide and/or between 10 mm to 10 to 50 mm wide and/or between 50 to 100 mm wide and/or between 100 mm to 1 meter wide. A container may be between 0 to 10 mm long and/or between 10 to 100 mm long and/or between 100 mm to 1 meter long. Optionally a container can have 1 wall and/or 2 and/or 3 and/or more walls.

Optionally, there may be containers for other foods (e.g., a spatula and/or strainer for collecting French fries and/or other deep-fried foods and/or tongs (e.g., for a barbecue) and/or an ice-cream scoop etc.). Optionally there may be fork shaped device that may connect and act with the scale.

### SPECIFIC EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

According to some embodiments, the electronic measuring container may be used by a variety of businesses and/or users, e.g., bakers, pharmacists, spice specialists, jewelers, restaurants, market stalls, and/or in any field in which precise measurement may be required. Advantageously, the electronic measuring container may be handheld and/or easily portable.

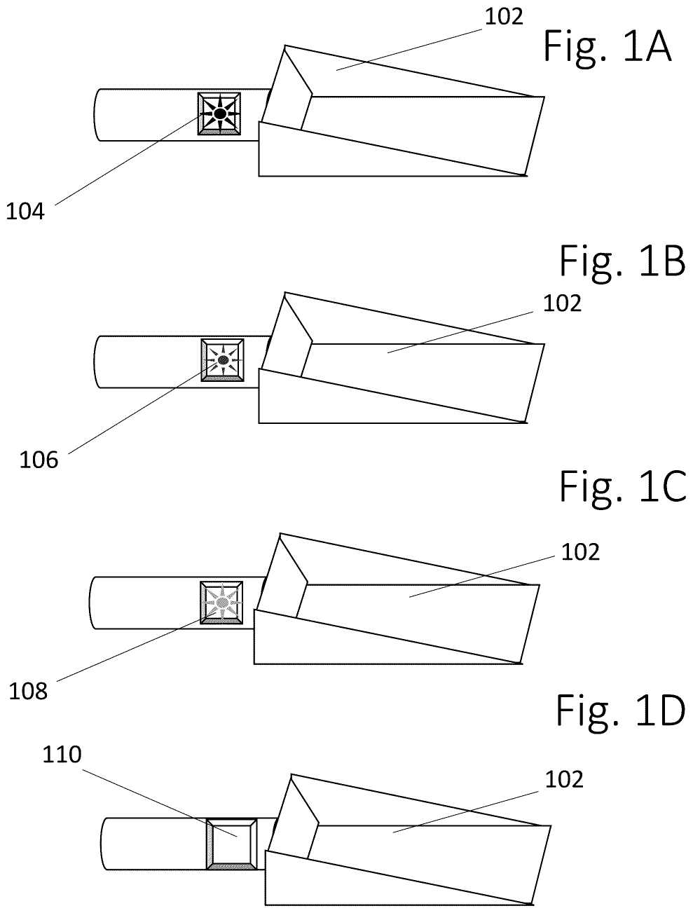

FIG. 1 is a schematic diagram illustrating an embodiment of the current invention. For example, FIGS. 1A-D. illustrate an electric container and/or electric scoop. An embodiment of the current invention may include an electronic container that may actively and/or periodically communicate to the user details and/or measurements of the contents of the container. Alternatively, and/or additionally, an electronic container may be configured to change size for a desired measurement (e.g., length, volume etc.). Alternatively, and/or additionally, an electronic container may include detachable (and/or washable) inserts (e.g., detachable scoops, spoons, trays, and/or bowls, etc.) that may optionally be of various shapes and/or sizes. Optionally, detachable inserts may assist in cleaning the container. Optionally, each insert may also communicate with a processor (e.g., a chip [e.g., an RFID, a storage device (e.g., a built-in flash memory), a special plug, a visible tag (e.g., a barcode and/or QR code, etc.)]). For example, the insert may report to the processor a total volume and/or a weight and/or location of a center of mass.

According to some embodiments, an electronic container may include a function for measuring weight (e.g., an electric and/or mechanical scale) and/or a function for measuring volume (e.g., a sensor and/or the electronic container may change size according to the desired volume) and/or length (e.g., a sensor and/or the electronic container may change size according to the desired length) and/or number (e.g., a sensor for detecting the number of items and/or racks that may hold a good and/or may change size to hold more or less goods, etc. and/or the electronic container may indicate how many times it was filled and/or emptied) and/or other measurements etc. Optionally, a user and/or a system may select a desired measurement for the electronic container to measure. Optionally, an electronic container may be set for a fixed measurement. Optionally, an electronic container may guide the user to measure the desired measurement. Optionally, an electronic container may communicate to the user if the amount in the electronic container is below and/or above the desired measurement and/or if the desired measurement has been reached and/or how much needs to be added and/or subtracted to reach the desired measurement.

According to some embodiments, an electronic container may communicate to a user in various ways. For example, an electronic container 102 may include a light system of different colors 104, 106, 108. For example, one color 104 may indicate that the contents are less than the desired amount, and/or another color 106 may indicate more or less than the desired amount and/or another color may indicate close to the desired amount and/or another color 108 may indicate that the desired amount has been reached. Alternatively, and/or additionally, an electronic container may include a visual indicator 110 (e.g., a flashing light, a symbolic and/or textual indicator, etc.) and/or an audible output (e.g., a sound system) and/or a vibration system and/or other system to indicate information about a measurement and/or communicate with a user. For example, a screen that may convey various measurement information and/or other information to the user. Optionally container may have various shapes and/or sizes.

According to some embodiments, the electronic container may be pre-programmed with various controls (e.g., activated by buttons). For example, there may be controls for various types of products and/or servings. For example, a restaurant may have various sized servings and/or a user may select a serving size and/or the electronic container may assist in measuring the desired serving size. Optionally, an electronic container may be programmable for multiple fixed servings (e.g., a defined amount may be defined as a portion of shawarma and the user may specify the electronic container to notify after multiple portions, such as 2 or 3 or 4 portions) and/or an electronic container may have a pre-programmed function to add or subtract a fixed amount from a standard serving (e.g., adding an additional fixed measurement and/or percentage of the good, etc.) and/or an electronic container may have a function for a user to manually insert a desired amount.

According to some embodiments, the electronic container may be designed for selling and/or processing food (e.g., a restaurant and/or bulk goods, specialty products, medicines, etc.) and/or for various other measured items (e.g., precious stones and/or metals, etc.). Optionally, the electronic container may be portable. Optionally, the electronic container may be handheld. Optionally an electronic container may have a handle.

In some embodiments, a container and/or scoop may be connected and/or disconnected with a connection mechanism. This may allow safe rinsing of the (shawarma) spoon without damaging the electronics in the handle.

In some embodiments, there may be a power on and/or off button and a button. For example, the on and/or off button may be on the handle. Optionally there may a button and/or buttons and/or settings to set desired amounts of meet and/or the system will alert the user when he reaches that amount (e.g., by a sound). Optionally a user may be able to set and/or save how much quantity is one and/or more portions and/or he may then set the device to alert him after several portions.

For example, if a customer ordered several portions—for example 4, the weight will show the quantity of portions and thus the employee will not have to calculate the quantity each time.

An optional embodiment may include a scoop designed for dry goods for example, nuts and/or spices.

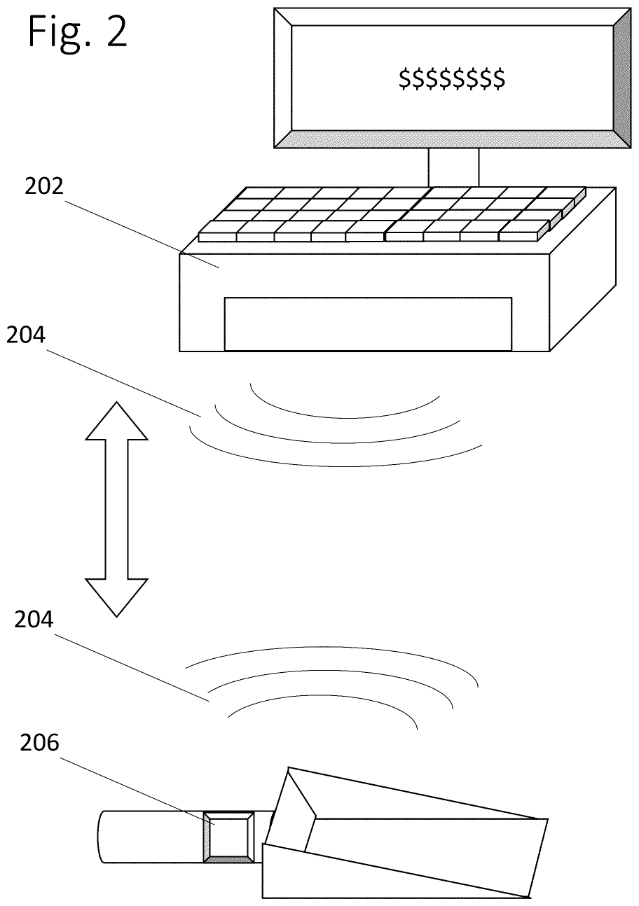

FIG. 2 is a schematic diagram illustrating an embodiment of the current invention. For example, the figure illustrates an optional aspect of an embodiment of the current invention. Some embodiments may include communication between various devices in a system. For example, a cash register 202 and/or a mobile device may communicate and/or send information to an electronic container and/or may receive information from an electronic container and/or another mobile device. For example, there may be an order station (for example the cash register and/or a waiter by a table (with a mobile device and/or communication device)) and/or a customer may send the order (e.g., from a mobile device (e.g., over a wireless connect for example by Bluetooth and/or a local network, for example by wi-fi) and/or remotely e.g., over the Internet, for example by wi-fi, Bluetooth, etc.). Optionally, the order may then be sent 204 (i.e., by wi-fi and/or other) to one of the electronic containers 206 to be processed. Optionally, the electronic container may display the order to a user (e.g., the kitchen staff and/or factory staff and/or store staff, etc.). Optionally, the order may be displayed on a screen of the electronic container and/or communicated by one or more communication functions on the container. Optionally, the order may be displayed on a screen located near the user and/or on a mobile device. For example, an order may be received and/or then the user (i.e., the worker that is supposed to prosses the order) may see the information on the electronic container screen and/or the electronic container may then guide the worker to reach the desired measurement. For example, kitchen staff may receive an order (e.g., for a certain size portion and/or various types of goods) and/or the order may be shown on the screen of the worker. Optionally, the screen and/or other communication functions on the electronic container may then guide the worker to the desired measurement. For example, orders may be made at an order station and/or cash register, the order station may then send the order information (e.g., what is ordered, the amount ordered, some way of identifying the ordering party, etc.) to the user and/or may automatically be sent to the user, to process the order. The electronic container may help the user efficiently measure the desired amounts of the various goods as they may be displayed on the screen of the electronic container device. Advantageously, this may increase efficiency in the kitchen staff's work.

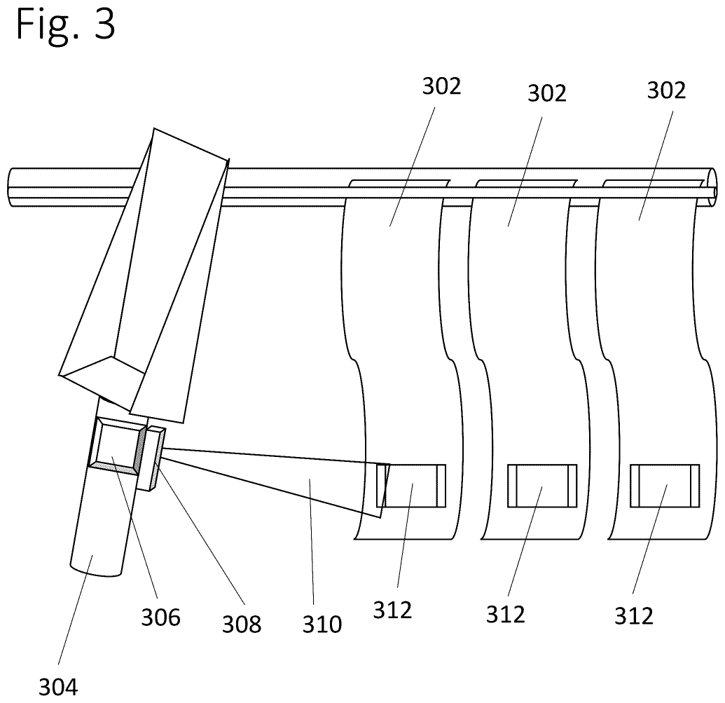

FIG. 3 is a schematic diagram illustrating an embodiment of the current invention. For example, the electronic container 304 may include a scanning function. Alternatively, and/or additionally, the electronic container may have a scanner 308 (e.g., optical reader that may read barcodes, QR codes and/or RFIDs). Optionally, the scanner may be connected to the processor and/or a display screen 306 of the electronic container 304 and may display the required goods and/or amounts. For example, an order sheet may be printed 302 and/or hung in the location where the order is being processed. The order sheet may include a barcode 312, QR code, RFID, etc. A user may scan 310 the barcode 312 with the scanner 308 on the electronic container 304 which may then display 306 and/or communicate the order to the worker. Alternatively, and/or additionally, an alternative device may scan the barcode, QR code, RFID and/or other ID and/or may then send the data to the electronic container (e.g., by wi-fi, Bluetooth, etc.).

Alternatively, and/or additionally, according to some embodiments, the system may geolocator tag. For example, a customer may place an order (e.g., from a table with a waiter and/or at the counter) and the order may be tagged with the customer's location (e.g., table location) and/or when the order is ready then a user may scan the order sheet to identify and/or display the customer location. Optionally, scanning may be performed by an electronic container scanning function and/or by a mobile device. For example, an order sheet may include a tag that the order needs to go to table 3 and/or after the order has been prepared, a user may scan the order sheet to identify that the order needs to go to table 3.

Alternatively, and/or additionally, according to some embodiments, a table may have an electronic tag and/or a customer may be provided with an electronic tag, which may be returned after use. Optionally, an electronic system may be used by a customer to order, such as, an ordering interface at the table location and/or near the entrance, etc. and/or an application to order on the customer's cellular phone. Optionally, the order may be sent over a network to the kitchen staff and/or processing staff and/or to an electronic container and/or the workers may process the order. Optionally, on completion the order, the customer location may be displayed, and/or the order sheet may be scanned to show the location of the customer (e.g., the customer's table), and/or the customer may be alerted that their order may be collected.

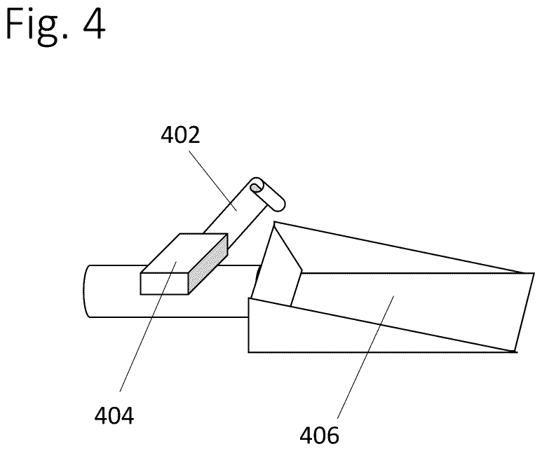

FIG. 4 is a schematic diagram illustrating any embodiment of the current invention. For example, the figure. illustrates an electronic container 406 with a printer 404 which may print stickers and/or receipts 402. Optionally, an electronic container may include a printing machine and/or may include a network connection to a printing machine. Optionally, a processed order may be reported on a receipt, e.g., after measuring the order, the receipt may be printed describing the details of the measurements and/or the costs of the final product. Optionally, a receipt may have a barcode, QR code, RFID, and/or other ID and/or the receipt. Optionally, the receipt may be scanned by the cash register to bring up the bill to be paid by the customer. Alternatively, and/or additionally, the electronic container may automatically (e.g., over a network, such as by wi-fi, Bluetooth, etc.) send the bill to the cash register to be paid. For example, a system may indicate that a customer ordered food (e.g., on a line, etc.), optionally, the customer may have an ID card and/or ID tag, such that each time a user gives the customer food then the ID card would be scanned by the user's electronic container (e.g., spoon, scoop, etc.) and the network may be updated that this customer received a particular product and the amount received. On completion of ordering and/or purchasing, the bill may be put together from the data received by the network for the particular customer. For example, a system may indicate that a customer ordered food (e.g., on a line, etc.), optionally, the customer's tray may be an electronic container have an ID card and/or ID tag, such that each time a worker gives the customer food the electronic container may scan a tag and/or label for that food product, and the network may be updated that this customer received a particular product and the amount received. Optionally, the electronic container may store such data until the customer may be billed. On completion of ordering and/or purchasing, the bill may be put together for the particular customer.

For example, in a cafeteria style place, a customer may go down the line ordering food and/or the users may scan the tray of the customer and/or may report what was ordered and/or may sent the data to the network database and/or on completion of ordering the customer tray (or customer ID) may be scanned and a bill may be brought up.

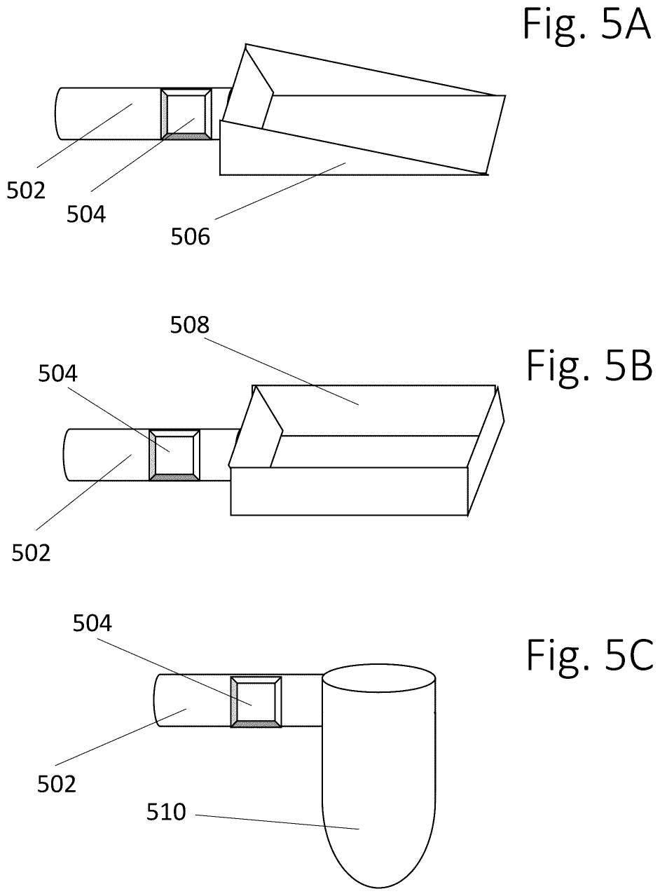

FIG. 5 is a schematic diagram illustrating any embodiment of the current invention. For example, the electronic container may be of various sizes, and/or shapes (FIGS. 5A-5C). Optionally, the electronic container 506, 508, 510 may be scoop shaped (e.g., for dry ingredients, spices, sweets, shawarma, etc.), and/or tray shaped (e.g., for liquids, meat, fish, poultry portions, vegetables, etc.) and/or cup shaped (e.g., for liquids, dry ingredients, etc.), and/or spoon shaped and/or other shapes. Optionally, the electronic container may be configured to allow attachment of various shaped containers to be reversibly attached and/or detached, e.g., depending on the item, good, product, and/or produce being measured. Optionally, the electronic container may interconvert from one shape to another. Optionally, an insert may be placed within the electronic container, e.g., to aid in cleaning, etc. Optionally, the electronic container may be portable. Optionally, the electronic container may be handheld. Optionally, the electronic container may include a handle 502 with a display screen and/or user interface 504 and a container 506, 508, 510.

For example, the electronic container may be large (e.g., for measuring bulk foods, such as dry ingredients, food portions, fresh produce, etc.) and/or small (e.g., for measuring spices and/or medicine). Optionally, the system may be used for large and/or small and/or medium objects (e.g., bulk food, restaurant portions, spices, medicine, etc.).

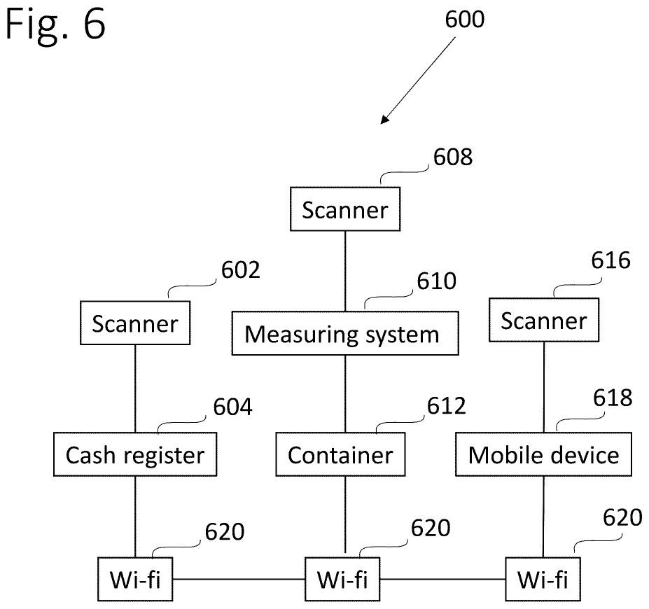

FIG. 6 is a block diagram illustrating an embodiment of the current invention. For example, a system 600 may include with a network 620 and/or a payments station (e.g., cash register 604 (which may have a scanner 602 to scan printed receipts and/or tags) and/or a system may include an application for mobile devices 618 (that may include a scanner 616 and/or a network connection). The mobile device 618 may be used for example, to order goods, and/or to send information to a worker (working in the orders processing station) and/or to send to a billing station. An embodiment may include an electronic container 612 which may connect with the payment station and/or a mobile device 618. An electronic container 612 may include a printer and/or a scanner 608 and/or may perform various measuring functions with a measuring system 610 and/or assistance functions. There may be system for a store front, and/or a factory, and/or sit-down restaurant (with waiters) and/or a takeout style restaurant and/or a cafeteria, and/or a shop and/or stall providing goods that require precise measurement.

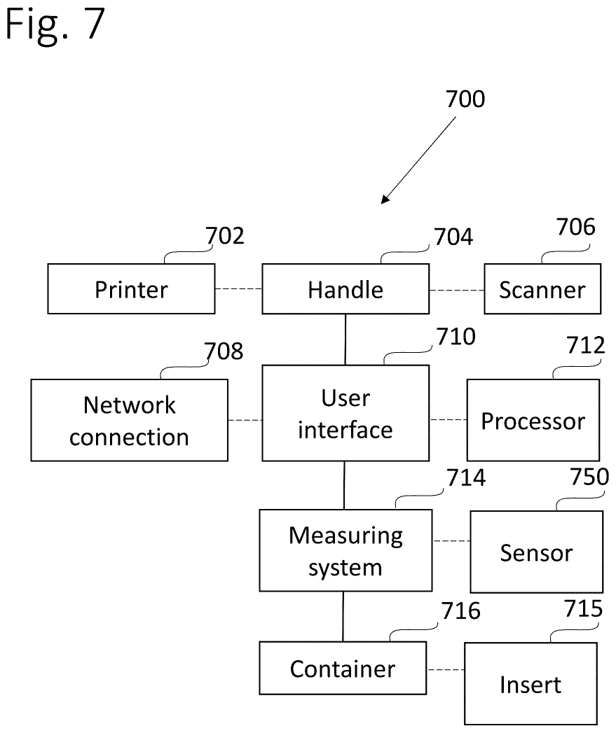

FIG. 7 is a block diagram illustrating an embodiment of the current invention. For example, the system 700 may include a handle 704 with a display screen and/or user interface 710, a measuring system 714, and a container 716, optionally the container may include one or more inserts 715. Optionally, the system 700 may additionally include a scanner 706, a printer 702, a network connection 708 and/or a processor 712, etc. Optionally, the electronic container may include one or more sensors 750, e.g., multiple load sensors, an accelerometer, and/or a gyro. Optionally, such sensors may be coupled to a processor e.g., to make allowance for movement of the electronic container and/or variations in the position of the object being weighed and/or the angle of the electronic container with respect to gravity, for accurate measurement in various cases.

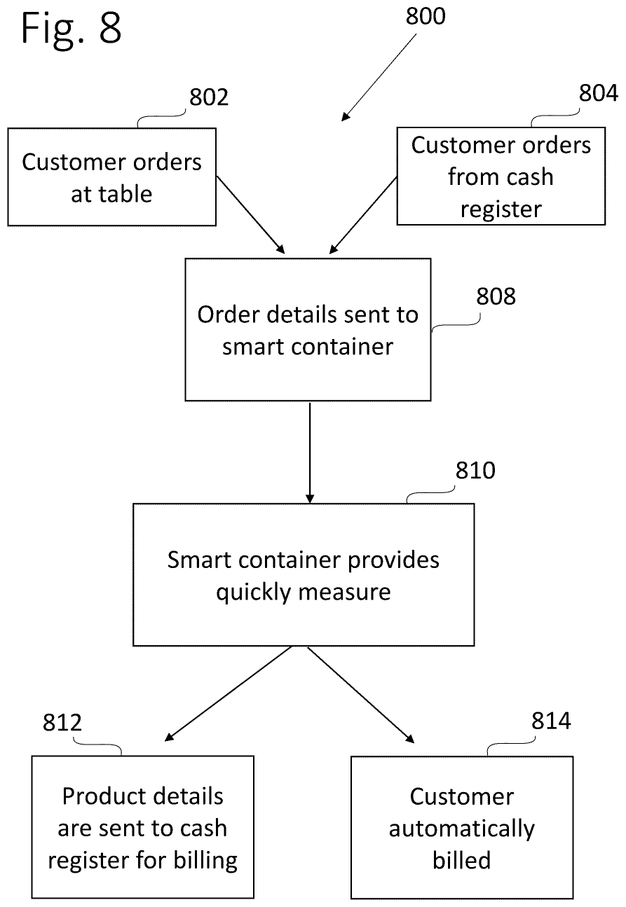

FIG. 8 is a flow chart illustrating an embodiment of the current invention. For example, in the method 800, a customer may place an order, e.g., at their table 802 and/or at the counter 804, the order details may be sent 808 automatically to the user and/or the smart container. The smart container may assist the user to quickly measure 810 the order. The product details may then be sent to the cash register for billing 812 with the final measurement. Alternatively, the system may be configured to automatically bill 814 the customer (e.g., the customer's credit card, bank account, electronic money transfer, etc.).

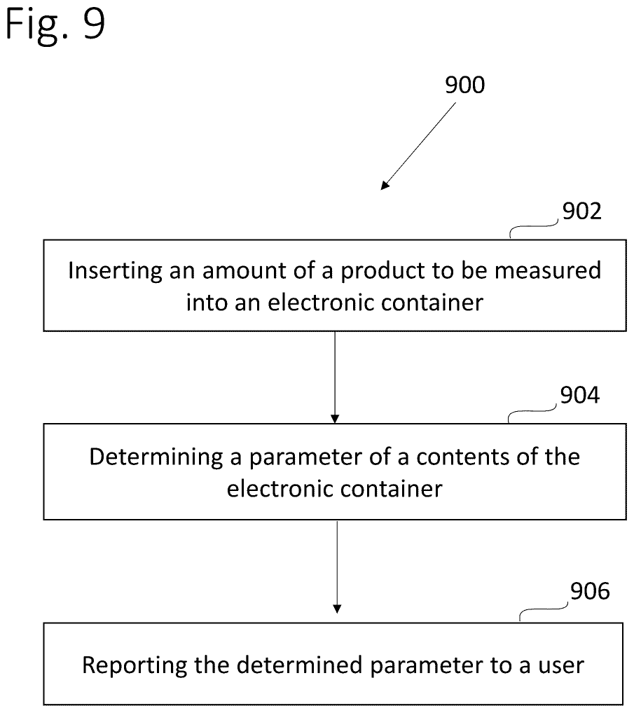

FIG. 9 is a flow chart illustrating an embodiment of the current invention. For example, a method for measuring contents of a container, the method 900 including inserting 902 an amount of a product to be measured into an electronic container, determining 904 a parameter of a contents of the electronic container, wherein the parameter is a mass, volume, length, or quantity thereof, and reporting 906 the parameter to a user. Optionally, the quantity may be a pre-determined and/or desired quantity. Optionally, the pre-determined and/or desired quantity may be sent to the electronic container, e.g., by a wi-fi connection, Bluetooth connection, etc. Optionally, the pre- determined and/or desired quantity may be sent to the electronic container by scanning a barcode, QR code, RFID and/or another identifier. Optionally, the reporting may be by a user interface (e.g., a visual system, an audio system, vibration system and/or any combination thereof), printing a receipt and/or sending a report to a billing apparatus (e.g., cash register, etc.). Optionally, the reporting may be over a wi-fi connection, Bluetooth connection, or both.

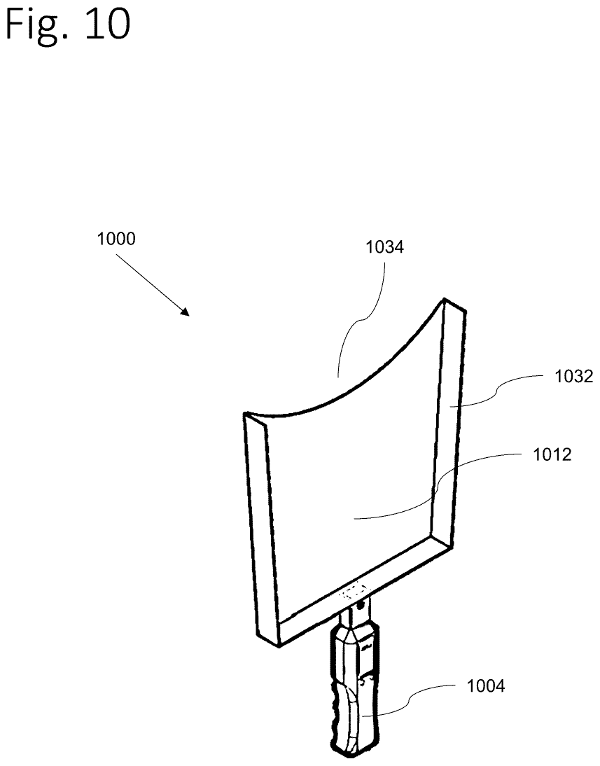

FIG. 10 is a perspective view of a weighing spatula 1000 in accordance with an embodiment of the current invention. An embodiment may be designed to be used for a specific type of food and/or family of foods and/or goods. For example, spatula 1000 may be designed to be used for shawarma. For example, spatula 1000 may include a container 1012 section may have the shape of a spatula and/or a flat tray with three walls 1032. Optionally, one side is connected (e.g., permanently or reversibly) to a handle 1004. Optionally, there is one open side 1034. In some embodiments, the open side 1034 is opposite the handle 1004. Alternatively or additionally, the open side may be adjacent to the handle 1004. Optionally, the open side 1034 may have a concave edge, e.g., to fit to a large pillar of meat. This may grant the user the normal functionality and ease of use when handling meat and/or other goods. For example, the spatula 1000 is similar to those standard used tools/containers. Optionally, handle 1004 is digital handle (for example, similar to one or more of the previously described herein e.g., for weighing contents of the container 1012). Additionally or alternatively, handle 1004 may reversibly attached and/or replaceable by a conventional handle. Optionally, handle 1004 may be attached to a scoop of another shape container. Optionally the scoop and/or container may connect sounding a click sound, so that the user can recognize when attached securely and/or properly.

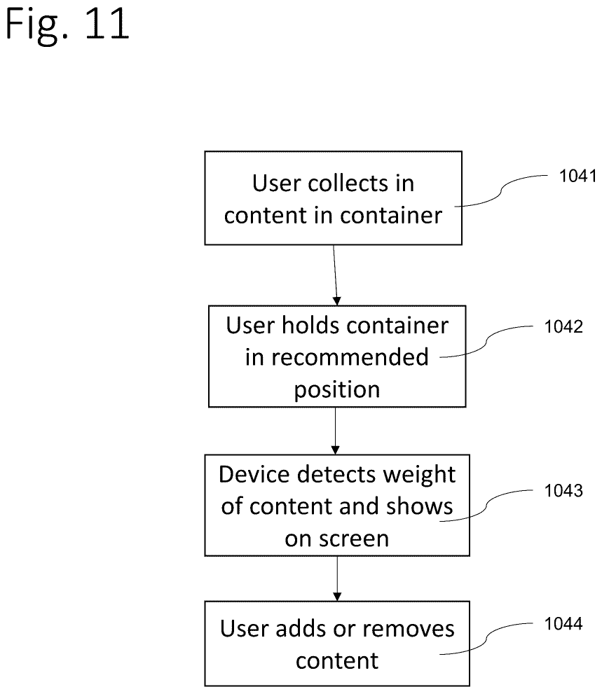

FIG. 11 is a flow chart illustrating method of weighing in accordance with an embodiment of the current invention. A user may collect 1041 content in the container. The user may then hold 1042 the container in the recommended position for more accurate results. The device may indicate 1043 if when it is ready to weigh accurately (e.g., the weight is stable and/or the angle is in an acceptable range). The device may then measure the wight of the content and show the user. A user may add or remove 1044 content as desired. Optionally, the measuring device may include an input interface to input a desired measure amount and/or the measuring device may indicate when that quantity is achieved.

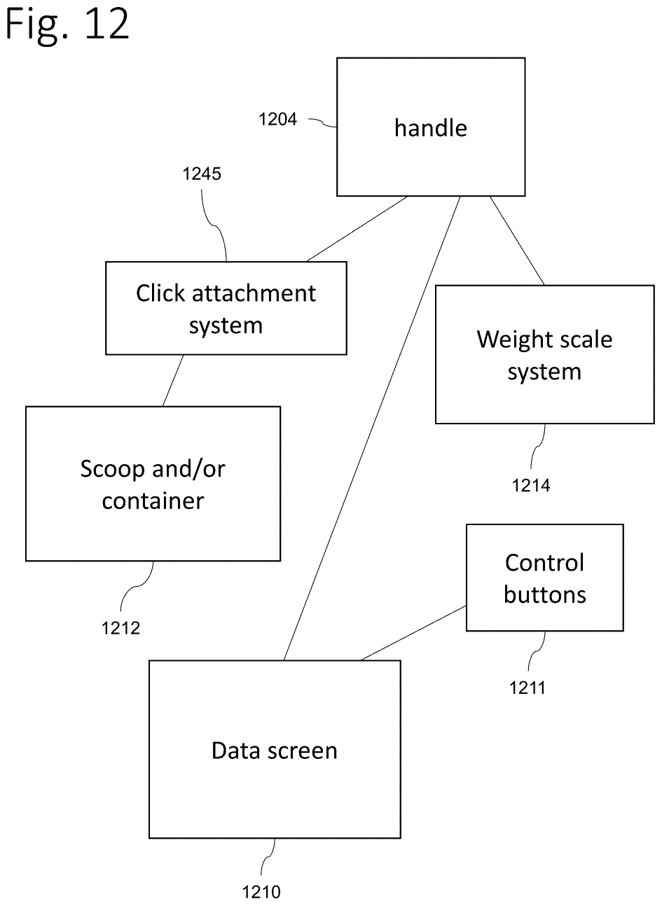

FIG. 12 is a block diagram illustrating an optional embodiment of the current invention. Components of an embodiment of the current invention may include a storage spoon/container 1212 and/or an attachable grip handle 1204 and/or a quick connection 1245 and/or quick disconnection between the container 1212 and a grip handle 1204. This may allow the container 1212 to be disconnected and/or washed and then reconnected connected to it for further operation. Optionally, the handle 1204 includes a data screen 1210 and/or a control button 1211. Alternatively or additionally, the input and/or output interface may include other controls (e.g., a touchscreen) and/or the device may be controlled wirelessly (e.g., the input/out interface may be connected to and/or controlled from and/or send output to a smartphone and/or a cash register). Optionally, the device includes a weighing system 1214 and/or a scale. For example, the weighing system 1214 may be built into the handle 1204.

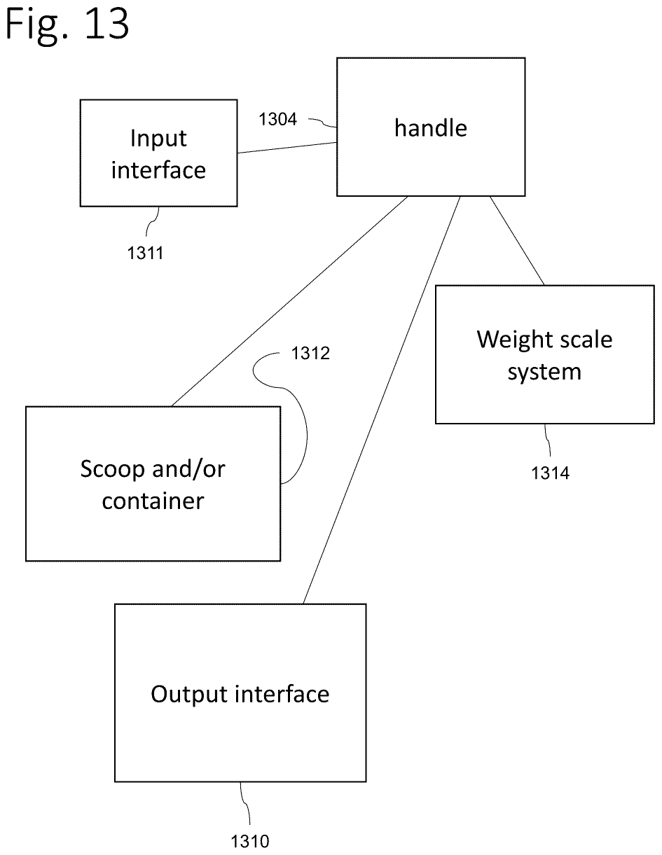

FIG. 13 is a block diagram illustrating an optional embodiment of the current invention. Components of an embodiment of the current invention may include a storage spoon/container 1312 and/or an attachable grip handle 1304. Optionally, the handle 1304 is permanently connected to the container 1312 and/or a quick connection may allow reversible connection and/or disconnection between the container 1312 and the handle 1304. Optionally, the handle 1304 includes a data output interface 1310 and/or an output interface 1311. Alternatively or additionally, the input and/or output interface may include other controls (e.g., a touchscreen) and/or the device may be controlled wirelessly (e.g., the input/out interface may be connected to and/or controlled from and/or send output to a smartphone and/or a cash register). Optionally, the device includes a weighing system 1314 and/or a scale. For example, the weighing system 1314 may be built into the handle 1304.

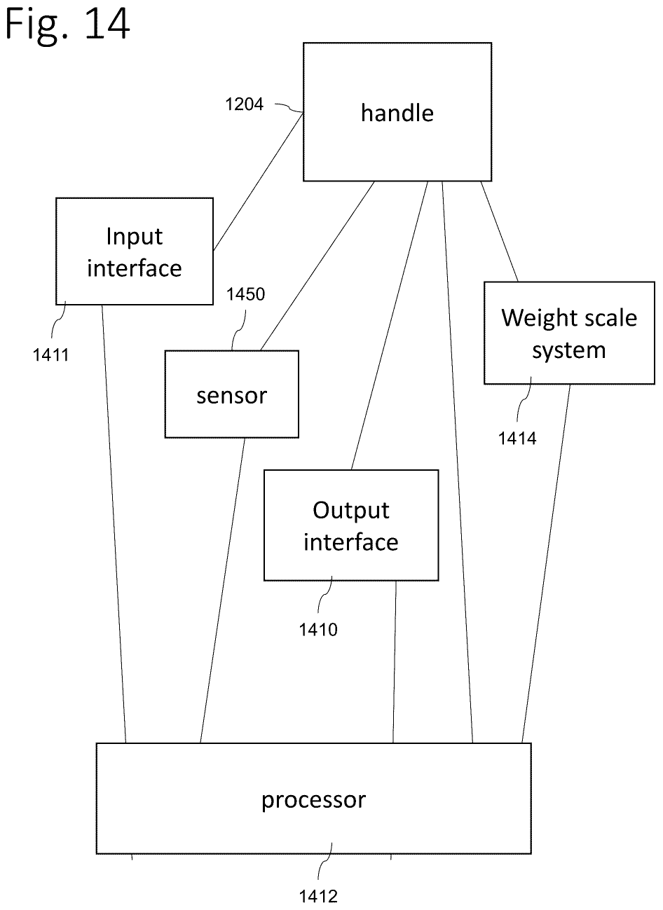

FIG. 14 is a block diagram of a position sensing mechanism in accordance with an embodiment of the current invention. In some embodiments, there may be sensors 1450 of how the device is being held (e.g., a gyro, an accelerometer). For example, the device may indicate that the device is being held at a proper angle and/or range of angles in order to receive an accurate reading of the scale. For example, this may be parallel to the ground and/or at an angle. Optionally there may be a sensor that may detect the angle that the spoon is being held and/or there may be a processor. For example, the processor 1412 may calculate the weight of the content according to the angle and/or may show the user the angle of the device. For example, if the scoop is held at a 45-degree angle upward the scale may detect less force on it and may thus give a reading the content is less heavy than reality. Optionally there may be a sensor 1450 that may sense acceleration. This may help to give a more accurate reading when the spoon in in motion. Optionally, there may be multiple weight sensors 1450 and/or the readings may be averaged and/or adjusted to allow for accurate measurement at different angles and/or when the object is at different positions in the device.

Components of an embodiment of the current invention may include a handle 1404. Optionally, the handle 1404 is permanently connected to a container. Optionally, the handle 1404 includes a data output interface 1410 and/or an output interface 1411. Alternatively or additionally, the input interface 1411 and/or output interface 1410 may include other controls (e.g., a touchscreen) and/or the device may be controlled wirelessly (e.g., the input/out interface may be connected to and/or controlled from and/or send output to a smartphone and/or a cash register) and/or the processor 1412 may be remote and/or communicate wirelessly with the handle 1404. Optionally, the device includes a weighing system 1414 and/or a scale. For example, the weighing system 1414 may be built into the handle 1404.

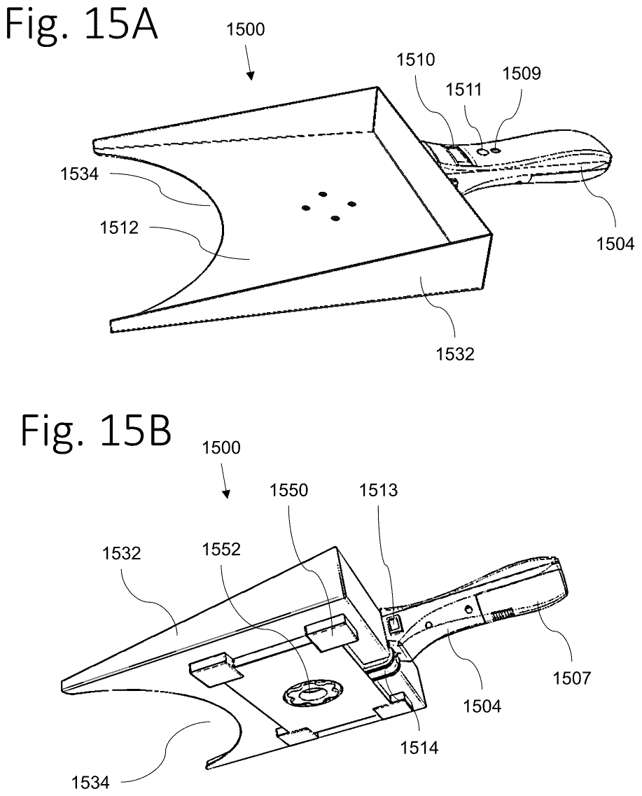

FIGS. 15A and 15B are perspective views of a weighing spatula 1500 from above and below in accordance with an embodiment of the current invention. An embodiment may be designed to be used for a specific type of food and/or family of foods and/or goods. For example, spatula 1500 may be designed to be used for shawarma. For example, spatula 1500 may include a container 1512 section may have the shape of a spatula and/or a flat tray with three walls 1532. Optionally, one side is connected (e.g., permanently or reversibly) to a handle 1504. Optionally, there is one open side 1534. In some embodiments, the open side 1534 is opposite the handle 1504. Alternatively or additionally, the open side may be adjacent to the handle 1504. Optionally, the open side 1534 may have a concave edge, e.g., to fit to a large pillar of meat. This may grant the user the normal functionality and ease of use when handling meat and/or other goods. For example, the spatula 1500 is similar to those standard used tools/containers.

In some embodiments, handle 1504 is digital handle (e.g., for weighing contents of the container 1512). For example, the handle may include an output interface including, for example a display screen 1510 and/or a level indicator 1509. Additionally or alternatively, the handle 1504 may include an on/off switch 1513 and/or a battery cover 1507. For example, the level indicator 1509 and/or the display screen 1510 may be on a top surface of the handle 1504. Optionally, the handle may include a user input interface, for example, including a tare button 1511 and/or an on/off switch 1513.

In some embodiments, handle 1504 may be reversibly attached to a scoop. For example, a user may detach the container 1512 and attach a scoop of another shape, of another shape container. For example, the handle 1504, may include an extension 1514, sensors 1550 and/or a latch 1552. For example, the extension 1514 may extend below and in front of the handle 1504. Optionally, the extension 1514 may serve as a platform for the container 1512. For example, the container 1512 may rest on the sensors 1550 (e.g., load sensors) and/or be latched to the extension 1514. For example, the latch 1552 is loosely screwed to the container 1512 such that the container 1512 still has limited freedom of movement in the vertical direction and/or its weight may be supported by a load sensor 1550. In some embodiments, multiple (e.g., four) load sensors 1550 detect the distribution of weight on the container 1512. Optionally, a processor estimates a mass of the contents based on the weight distribution. Optionally, the mass and/or the number of portions is displayed on the user output interface (e.g., view screen 1510 (which may also include a touch screen)).

In some embodiments, a user cuts a portion of food (e.g., meat from a post of shwarma). While cutting the container 1512 is held at a convenient angle (e.g., tipped upward) so that the food falls into the container 1512. When the user desires, he tilts back the container to a prescribed weighing angle (e.g., horizontal, for example based on the level indicator). At the prescribed angle, the weight and/or number of portions in indicated on the view screen 1510 and/or sent wirelessly to another device.

### GENERAL

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon.

Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, and/or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Data and/or program code may be accessed and/or shared over a network, for example the Internet. For example, data may be shared and/or accessed using a social network. A processor may include remote processing capabilities for example available over a network (e.g., the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An electronic utensil evaluation system comprising:
a handgrip
a blade
a load sensor between said handgrip and said blade;
a further sensor; and
a processor configured to receive data from the load sensor and the further sensor and for estimating a parameter of a contents supported on said blade.

2. The system according to claim 1, wherein the further sensor includes a gyro, accelerometer, strain gauge, load sensor, or any combination thereof.

3. The system of claim 1, further comprising an output interface located on the utensil.

4. The system according to claim 3, wherein the output interface includes a display, a screen, a visual indication, an audible indication, an audiovisual indication, a tactile indication, a printout, or any combination thereof.

5. The system according to claim 3, wherein output interface produces a visual output includes a flashing light, a colored light, a variable intensity light, a symbolic, and/or textual indicator, other system to indicate information about a measurement and/or communicate with a user, or any combination thereof.

6. The system according to claim 3, wherein the output interface produces an audible indicator including at least one of a voice, a buzz, a tone, and a series of sounds.

7. The system according to claim 3, wherein the output interface produces a tactile indication including a vibration.

8. The system according to claim 1, wherein an output interface of the utensil includes a network connector.

9. The system of claim 8, wherein the output interface includes a display includes connected to the processor by the network connector.

10. The system of claim 8, wherein the network connector is wireless.

11. The system according to claim 1, wherein the blade of the utensil is reversibly connected to the handgrip.

12. The system according to claim 1, wherein the blade is permanently connected to the handgrip.

13. The system according to claim 1, further comprising a stand configured to facilitate the utensil standing on a surface.

14. The system according to claim 1, wherein said blade is configured to support at least one of a solid, a semi-solid, a liquid and a powder.

15. A method for measuring a portion of a product, the method comprising:
supporting portion on a blade of a utensil;
holding the blade with a handgrip of the utensil;
measuring a load between the blade and the handgrip;
also measuring a condition of the utensil; and
evaluating a parameter of the portion with a processor located on the utensil based on the load and the condition.

16. The method of claim, 15 further comprising:
Determining whether results of said measuring and said also measuring are suitable for said evaluating.

17. The method of claim 15, further comprising: outputting the parameter to a local display.

18. The method according to claim 15, further comprising outputting a notification when said portion includes a predetermined property.

19. The method of claim 18, wherein said notification is for any one of a plurality of predetermined properties.

20. The method according to claim 15, wherein said blade is reversibly attached to said handgrip and further comprising: detaching said blade and attaching a second blade to the handgrip.
